(19) United States
(12) Patent Application Publication
(10) Pub. No.: US 2012/0126029 A1
(43) Pub. Date: May 24, 2012

(54) Water-Powered Multi-Mode Waterway Oscillator

(76) Inventor: Esmoreit Ernest Koetsier, Norco, CA (US)

(21) Appl. No.: 12/950,881

(22) Filed: Nov. 19, 2010

(51) Int. Cl. B05B 3/16

(52) U.S. Cl. 239/242

(57) ABSTRACT

A water-powered multi-mode waterway oscillator has a main conduit directing a main fluid flow. The main conduit has a fixed end, and a driven gear coupled to a rotatable end. Control conduit redirects a portion of the main flow to turn a waterwheel, drive shaft, and main drive gear. A rotatable engagement arm with first and second ends has a center of rotation concentric with the drive shaft, a continuous drive gear is rotatably pinned to the first end and configured to engage the main drive gear and the driven gear, and an oscillating drive gear is coupled to the drive shaft, rotatably pinned to the second end, and configured to engage the driven gear. The engagement arm may be manually rotated between first and second positions. In the first position, the continuous drive gear engages the main drive gear and the driven gear to cause continuous rotation of the rotatable end of the main conduit. In the second position, the oscillating drive gear engages the driven gear to cause alternating rotation of the rotatable end of the main conduit. The rotatable end may be configured for attachment to a water cannon nozzle.

### BACKGROUND OF THE INVENTION

1. Field of the Invention

The present invention relates generally to mechanical oscillators for water cannons, such as those used to deliver high volume, high pressure fluid for applications such as fire suppression. More specifically, the invention relates to a water powered waterway oscillator that can change oscillation modes between continuous circular mode and alternating rotational mode.

2. Description of Related Art

Water cannons, also known as fire monitors and deluge guns, have been an effective tool in fire suppression systems for many years. Water cannons are designed to deliver a high pressure stream of fluid through a nozzle to saturate a desired area with large volumes of water, foam, or other fire suppressant. Most water cannons tend to be heavy apparatus, usually portable only by boat or truck, that are made essentially stationary when in use. Water cannons can be manually aimed, for example, by a fireman directing water into a burning building or into a crowd for riot control. Or, a water cannon may be locked into position and unmanned, to deluge an area without requiring the presence of an operator. This allows a single operator to move between multiple water cannons, adjusting their aim as necessary to suppress the fire. In other uses, an unmanned water cannon may be set up to douse a wide area of brush or other combustible debris for a prolonged period in advance of an oncoming wild fire, or it may be set up in a dry area to suppress dust and preserve visibility.

Water cannons may also be made to oscillate by providing a means for automatically moving the nozzle, or by automatically moving the waterway that connects to the nozzle. One type of oscillating water cannon uses a continuous circular oscillator that rotates in a 360 degree circular pattern. Another type of oscillating water cannon alternates its rotational direction (clockwise, counterclockwise, clockwise, etc.) as it sweeps back and forth though a circular arc. Either type of oscillator may be powered from an external source, such as an electric or hydraulic motor, or it may be powered using pressure in the flow of main fluid.

Externally powered water cannon oscillators are unsuitable in many applications. For example, electric power may not be available in a remote or undeveloped location, such as a desert or national park. Or an external power source may be rendered unavailable as a result of the same catastrophe, such as an earthquake or industrial accident, that caused the fire against which the water cannon must be deployed. And in general, it may be undesirable to introduce into a fire zone a combustible, petroleum-based fluid needed for operating a hydraulic motor.

Water-powered oscillators address these problem, but introduce another. State-of-the-art water-powered water cannon oscillators generally fall into two categories: continuous circular oscillators and alternating rotational oscillators. The choice of oscillator depends on the circumstances of use. For fire suppression in a burning building, an alternating rotational oscillator would allow a water cannon stationed in an adjacent street to sweep back and forth along a desired angle, e.g. 120 degrees, to deluge the building most effectively. For dust suppression near a remote landing strip, a continuous circular oscillator would allow a water cannon to deluge the maximum possible area. The problem with using water power to cause oscillation is that, unlike a controllable electric motor, a water-powered oscillating system cannot be programmed to change oscillating modes from continuous circular to alternating rotational.

To change the oscillating mode of a water-powered oscillator, a technician would need to modify the system to install a different driving mechanism, which is time-consuming and which introduces risk of injury to personnel and damage to equipment when removing pins, disconnecting flanges, etc. End users must therefore either double their inventory of water cannon oscillators, or suffer the inconvenience of having to mechanically reconfigure their oscillators in the field. What is needed is a waterway oscillator that can be very easily manipulated in the field to change its oscillating mode.

### SUMMARY OF THE INVENTION

The present invention provides an engineering design for a waterway oscillator that directs a high power, high pressure flow of fluid such as water through an outlet for industrial applications such as fire suppression. The waterway oscillator is configured to switch oscillating modes between circular oscillation in one rotational direction, and an alternating rotational oscillation between selectable end points of a circular arc. The invention is further characterized by a mechanical configuration that diverts a portion of main fluid flow through a control port to serve as the motive force for causing either mode of oscillation.

In one embodiment, a water-powered multi-mode waterway oscillator includes a main conduit directing a main flow of water and having a fixed end and a rotatable end, and a driven gear fixed or coupled to the rotatable end. A control conduit redirects a portion of the main flow from the main conduit to provide an auxiliary flow to a control outlet. A waterwheel is positioned to receive the auxiliary flow, and is configured to rotate a drive shaft in response to impact of water from the control outlet. A main drive gear is coupled to the drive shaft so that it rotates continuously in response to the auxiliary flow. A rotatable engagement arm is positioned above the main drive gear and configured to rotate between first and second engagement positions. The engagement arm has first and a second ends. A continuous drive gear is rotatably pinned to the first end and configured to engage the main drive gear and the driven gear. An oscillating drive gear is coupled to the drive shaft, rotatably pinned to the second end, and configured to engage the driven gear. A means for translating the engagement arm between the first and second positions is mounted to the waterway oscillator so that in the first position, the continuous drive gear engages the main drive gear and the driven gear to cause continuous rotation of the rotatable end of the main conduit, and so that in the second position, the oscillating drive gear engages the driven gear to cause alternating rotation of the rotatable end of the main conduit.

A waterway oscillator according to the invention may be enhanced with various additional features as follows: The main conduit may be configured for attachment to a water cannon nozzle. A flow control valve may be installed between the main conduit and the control outlet. The waterwheel may be coupled to the drive shaft through gear reduction. The main drive gear may be concentrically coupled to the drive shaft. The engagement arm may be located so that its center of rotation is concentric with the main drive gear.

A waterway oscillator according to the invention may be further characterized by its mechanism for providing alternating rotational oscillation. The oscillating drive gear may have a geared end and a driving end and may be pinned to the second end of the engagement arm at a pivot point between the geared end and the driving end. A pivot drive arm may be coupled to an end of the drive shaft and extend perpendicularly therefrom. A push rod having a proximal end coupled to the pivot drive arm at a point displaced from the end of the drive shaft and having a distal end coupled to the driving end of the oscillating drive gear converts continuous rotating motion of the drive shaft into alternating rotational motion of the oscillating drive gear about the pivot point. The pivot drive arm may include a means for adjusting displacement of the proximal end of the push rod from the end of the drive shaft to change rotational span of the oscillating drive gear.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. Dimensions shown are exemplary only. In the drawings, like reference numerals may designate like parts throughout the different views, wherein:

FIG. 1 is a front view of one embodiment of a water-powered multi-mode waterway oscillator according to the invention.

FIG. 2 is a rear view of the waterway oscillator of FIG. 1.

FIG. 3 is a left side view of the waterway oscillator of FIG. 1.

FIG. 4 is a right side view of the waterway oscillator of FIG. 1.

FIG. 5 is a top view of the waterway oscillator of FIG. 1.

FIG. 6 is an isometric view of the waterway oscillator of FIG. 1, shown with the cover removed.

FIG. 7 is a top view of the waterway oscillator of FIG. 1, shown with the engagement arm in an intermediate position and with the cover partially cut away.

FIG. 8 is a bottom view of the waterway oscillator of FIG. 1.

FIG. 9 is a top cutaway view of the waterway oscillator of FIG. 1, shown in continuous rotational oscillation mode.

FIG. 10 is a top cutaway view of the waterway oscillator of FIG. 1, shown in alternating rotational oscillation mode.

FIG. 11 is a front view of the waterway oscillator of FIG. 1, with a water cannon nozzle and monitor installed.

FIG. 12 is a top view of the waterway oscillator of FIG. 11.

### DETAILED DESCRIPTION OF THE INVENTION

The following disclosure presents an exemplary embodiment for a water powered multi-mode waterway oscillator according to the present invention. The embodiments depicted and described herein are intended to deliver a high power, high pressure flow of water through a flanged outlet configured for connecting to a nozzle or water cannon. So configured, the waterway oscillator may be employed most effectively for industrial applications such as fire and dust suppression. The inventive features of the waterway oscillator allow it to switch oscillating modes between (1) circular oscillation in one rotational direction, and (2) alternating rotational oscillation between selectable end points of circular arc. The invention is further characterized by a mechanical configuration that diverts a portion of main fluid flow through a control port to serve as the motive force for causing either mode of oscillation.

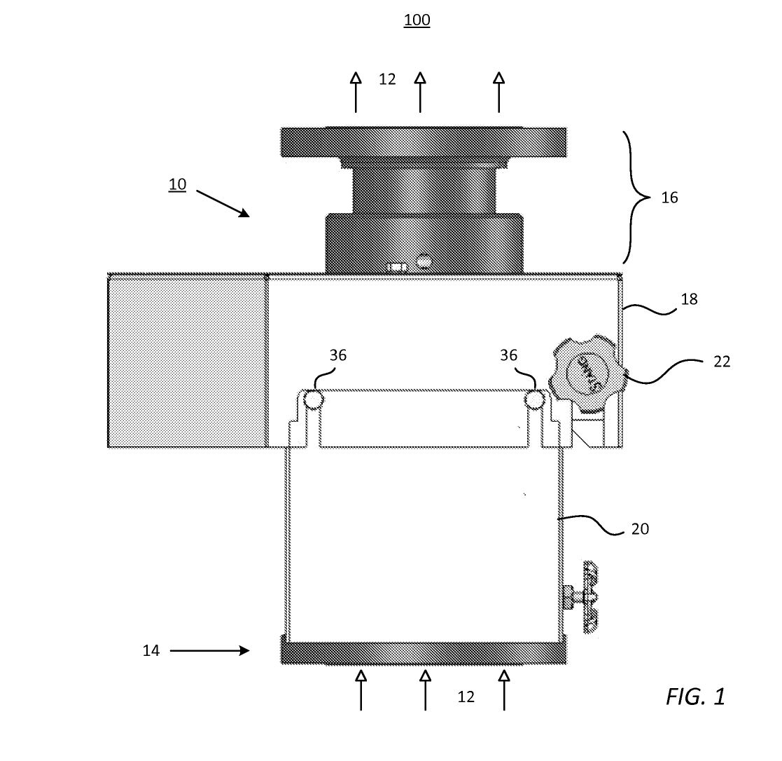

FIG. 1 shows a frontal view of one embodiment of a water-powered multi-mode waterway oscillator 100 according to the invention. Waterway oscillator 100 is essentially a large diameter, specialized pipe fitting designed for industrial use. The materials and configuration of the waterway oscillator 100 are designed, for example, to handle water flow rates of between about 150 gpm and about 3000 gpm, at a typical pressure rating of about 100 psi. The waterway oscillator is a specialized pipe fitting because it includes an auxiliary mechanical control system that uses the kinetic energy of the water to cause one end of the pipe fitting to oscillate, either continuously in a circle, or back and forth along a circular arc having a user-selectable arc length. These inventive features are described below in further detail.

The waterway oscillator 100 is generally characterized by a main conduit 10 that directs a main flow of water 12 from a fixed end 14 of the main conduit, toward a rotatable end 16 of the main conduit. Rotatable end 16 may be coupled to fixed end 14 by means of a bearing or bearing structure that allows the rotatable end to swivel or rotate with respect to the fixed end 14. The rotational direction of rotatable end 16 lies in a plane normal to the vertical direction of flow 12 and about an axis that is concentric with the main conduit. Each of the fixed and rotatable ends 14 and 16 may be configured as flanged pipe fittings, as shown, to facilitate connection to other components of a water delivery system. In one embodiment, the main conduit may comprise a 4-inch pipe, with flanged ends rated in the 150# pressure class.

A protective cover 18 may be mounted to the main conduit 10 to protect personnel from moving parts of the internal oscillating mechanisms, and to provide a barrier against weather and foreign material intrusion. A shield 20 may be mounted to the protective cover to provide similar protections for the mechanical control system.

Waterway oscillator 100 may also be equipped with manual controls. A mode-selecting knob 22 allows an operator to change the oscillating mode by turning the knob 22 clockwise or counterclockwise. A hand wheel 24 allows the operator to open a control valve and divert a portion of the main flow 12 to the mechanical control system to energize the oscillator and cause the rotatable end 16 to oscillate according to the selected mode.

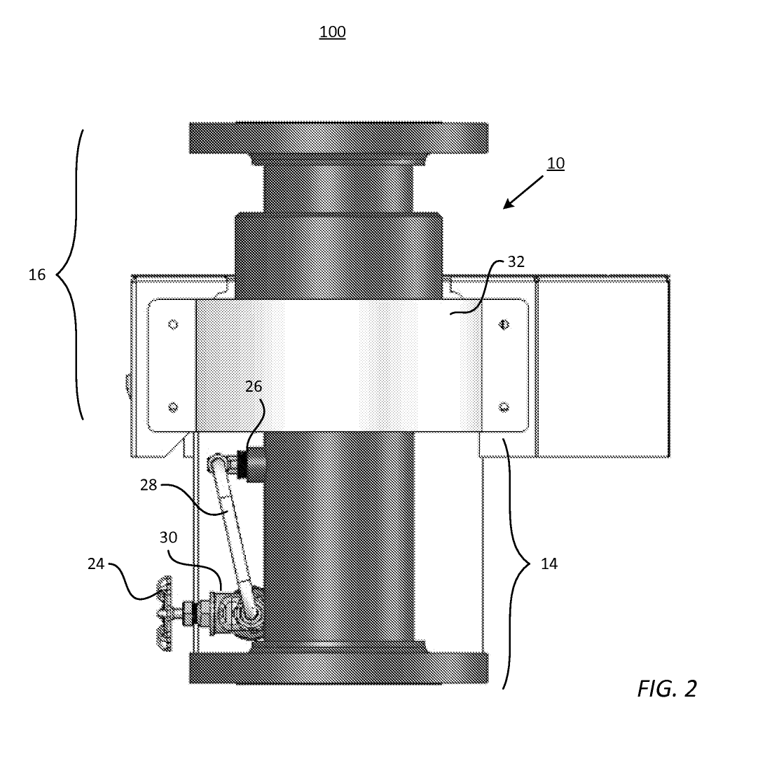

FIG. 2 provides a rear view of the waterway oscillator 100. This view shows a portion of the mechanical control circuit, which includes a control port 26, control conduit 28, and the control valve 30. Control port 26 may be formed on the side wall of the fixed end 14 of main conduit 10 at a location and in a manner that facilitates external hydraulic connection. The control port 26 defines a hole through the side wall, so that when water or other fluid flows through the main conduit, pressure in the main conduit directs a portion of the main flow through control port 26 and into control conduit 28. In one embodiment, the control port and control conduit may have an inner diameter anywhere between about 0.5 and 1.0 inches. In this configuration, by way of example, a pressure of around 40 to 50 psi within the main conduit may be sufficient to energize the mechanical control system via control conduit 28.

A control valve 30 may be placed between control port 26 and a downstream control outlet, to regulate flow through the control conduit, or to turn the flow off and shut down the oscillators. Control valve 30 may be of any conventional design, such as a globe or gate valve, that is rated to withstand main conduit pressure and designed for compliance with an appropriate industrial code or standard such as an NFPA standard. Control port 26, control conduit 28, and control valve 30 may be configured for attachment by means of conventional pipe fittings, such as threaded, welded, swage, and compression fittings.

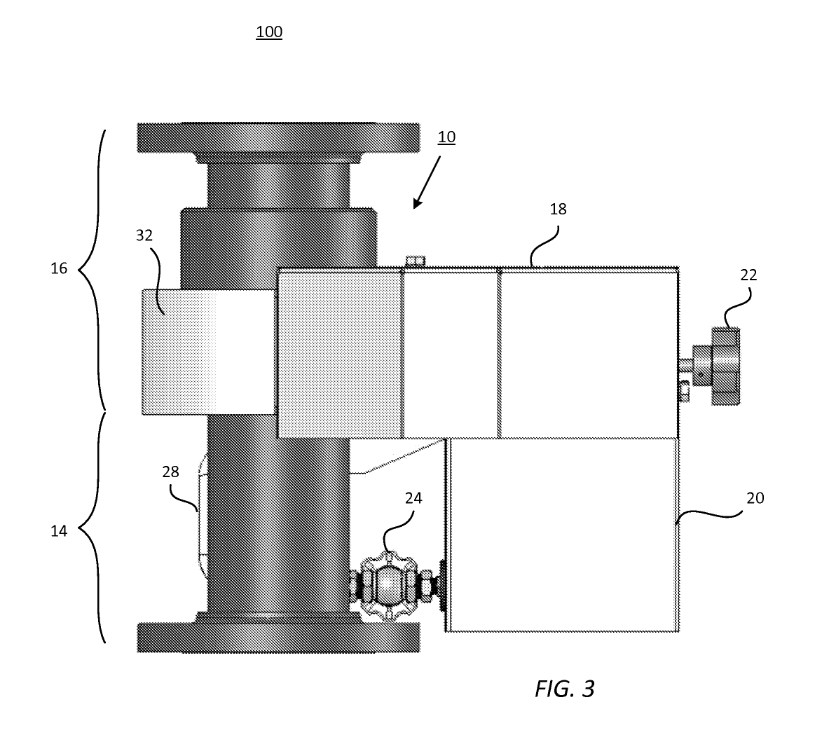

FIG. 3 shows a left side view of waterway oscillator 100. This view demonstrates the location of manual controls 22 and 24 with respect to the main conduit 10. Preferably, these controls are located for easy access by an operator, who may safely and easily manipulate either control without opening a protective cover and without risking injury from moving parts of the control or oscillating mechanisms. The view also shows a protective cover 32, which shields a driven gear, bearings, and seals that are responsible for transmitting force to the rotatable end 16, and allowing it to rotate with respect to the fixed end 14 without allowing leakage of fluid from the main conduit.

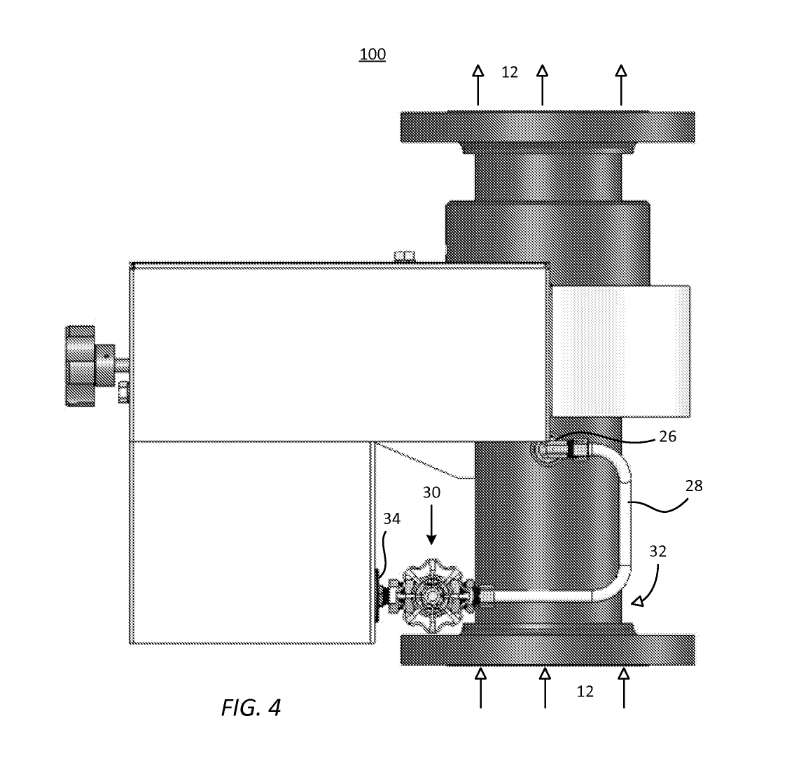

FIG. 4 shows a right side view of waterway oscillator 100. This perspective best demonstrates the configuration of the control conduit 28 and the positions of control port 26 and control valve 30. Many other configurations of these components are possible within the scope of the invention, so long as they cooperate to tap an auxiliary flow 32 of main fluid from the main flow 12 sufficiently to energize the mechanical controls housed within shield 20. Thus, the exact form and placement of these components with respect to the fixed conduit 14 is largely a matter of design, and may be influenced by considerations such as ease of manufacturing, maintenance, and operability.

On the downstream side of control valve 30, an additional length of conduit extends a short distance from the control valve and terminates in a control outlet 34 at the entrance into shield 20. It should be appreciated that control valve 30 is an optional component, and may be eliminated from the design in certain embodiments of the invention, such that conduit 28 may be extended until terminating at the control outlet 34. The inclusion of control valve 30, however, may provide an operator with a means to throttle the speed of the mechanical oscillators.

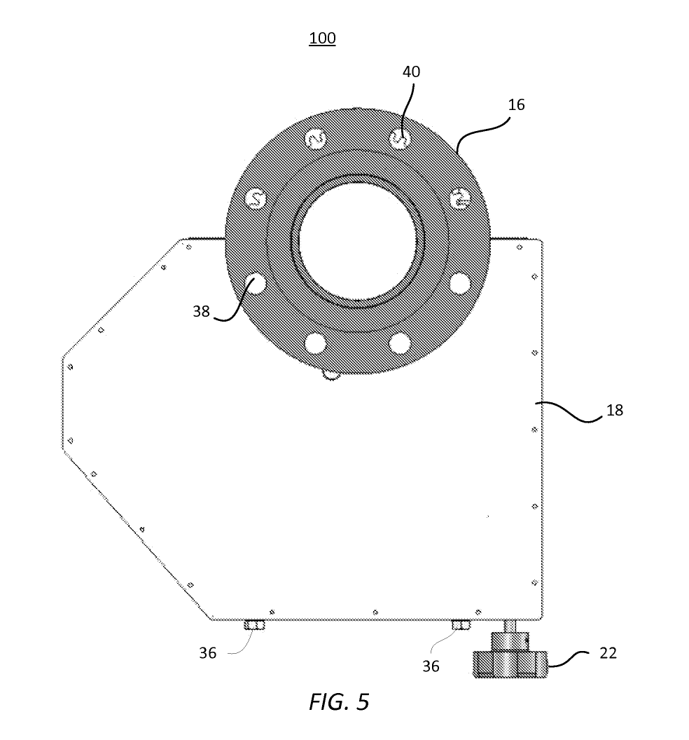

FIG. 5 shows a top view of waterway oscillator 100. Visible in this view are fasteners 36, which may be used for mounting the protective cover 18. Also visible are the bolt holes 38 formed on the top surface of rotatable flange 16. Gear teeth of driven gear 40 are visible through the bolt holes. The driven gear 40 may be fixed directly to the rotatable flange 16.

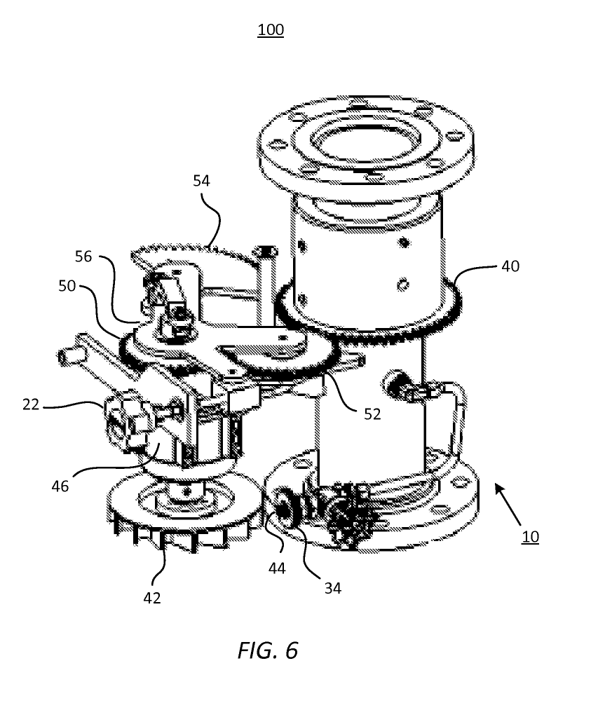

FIG. 6 shows an isometric view of waterway oscillator 100 with all shields and protective covers removed to reveal the working parts of the mechanical control system. The mechanical control system includes the components 27, 28, 30 and 34 that are responsible for delivering the auxiliary flow 32, and also includes the mechanism of gears and linkages shown to the left of the main conduit 10 that are energized by the auxiliary flow.

A waterwheel 42 equipped with a plurality of blades around its perimeter is suspended from the mechanism and positioned to receive the auxiliary flow 32 as it exits the control outlet 34. A nozzle 44 may be attached to the control outlet to accelerate and direct the auxiliary flow so that it impacts the blades of waterwheel 42 in such a way so that it maximizes energy transfer from the auxiliary flow to the waterwheel. In one embodiment, waterwheel 42 may be a Pelton wheel. The impact of fluid jetting from control outlet 34 onto the blades of the waterwheel causes the waterwheel to rotate, which from the perspective shown would be in a clockwise direction. After impacting the waterwheel, the auxiliary flow of water may be allowed exit the mechanism by spilling to the ground.

In one embodiment, the rate of auxiliary flow that impacts the waterwheel 42 may be between about 5 and about 10 gpm, causing the waterwheel to rotate at between about 1650 and 1750 rpm. Waterwheel 42 includes a central shaft that is connected to an input side of a gear box 46. Any type of gear box, such as one containing worm gears or planetary gears, or some combination of the two, may be employed within the scope of the invention. Gear box 42 may be designed for gear reduction to lower the speed and increase the torque delivered to the output or drive shaft 48 of the gear box. By way of example, a gear ratio in the range of about 200:1 to 400:1 should produce sufficient torque to move the driven gear 40 of the main conduit 10 at a speed in the range of about 4 to about 6 cycles per minute.

The drive shaft 48 of gear box 42 extends through the top of the gear box, where it connects to a main drive gear 50, so that rotation of the drive shaft causes rotation of the main drive gear. In the embodiment shown, main drive gear 50 is fixed concentrically to drive shaft 48, though other configurations are possible. During proper operation, as long as main flow 12 provides a continuous source for auxiliary flow 32, and provided that control valve 30 passes a sufficient amount of the auxiliary flow, waterwheel 42 will drive the gear box and cause drive shaft 48 to rotate main drive gear 50 continuously. The continuous rotation of the main drive gear provides the motive force required to oscillate the waterway in either rotational mode.

In circular oscillation mode, the continuous rotation of main drive gear 50 may be transmitted to the driven gear 40 when a continuous drive gear 52 is moved to a position so that it engages both the driven gear 40 and the main drive gear 50. In alternating rotational oscillation mode, the driven gear 40 may be oscillated back and forth between end points of a circular arc when engaged by an oscillating drive gear 54. The oscillating drive gear 54 derives its alternating motion from the continuous rotation of main drive gear 50, as explained below in further detail.

An engagement arm 56, which may be mounted above continuous drive gear 50, may be employed to move the continuous drive gear 52 or the oscillating drive gear 54 into a position for engaging the driven gear 40. In the present embodiment, engagement arm 56 is rotatable, and supports the two drive gears at different locations, so that one or the other of the drive gears may be rotated into an engagement position with driven gear 40. The engagement arm 56 may be rotated manually by means of mode-selecting knob 22.

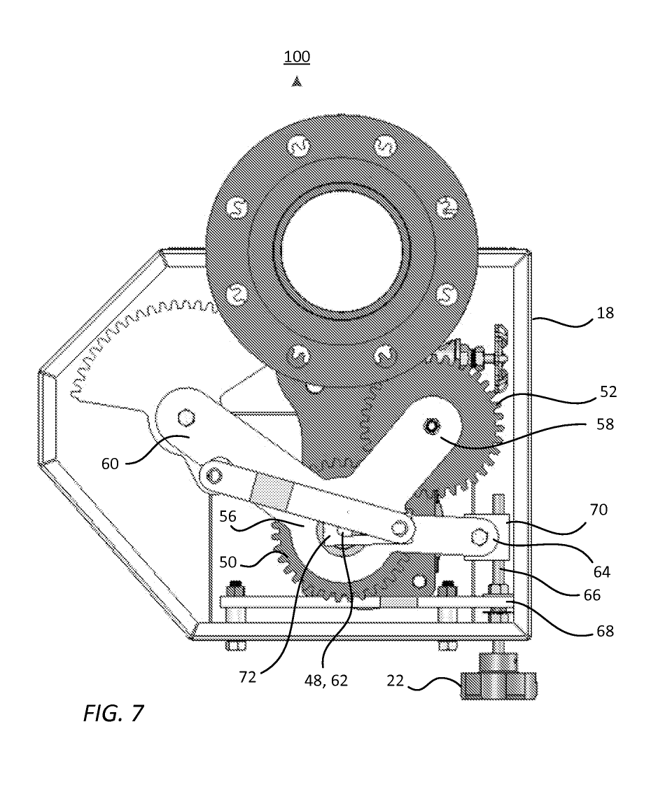

FIG. 7 shows a top view of waterway oscillator 100 with the cover partially cut away to reveal the working parts of the mechanical control system. In this view, the waterway oscillator 100 is shown with the engagement arm 56 in an intermediate position. That is, the mode-selecting knob is adjusted so that neither the continuous drive gear 52 nor the oscillating drive gear 54 is engaging the driven gear 40.

The rotatable engagement arm 56 may be configured with a first end 58 and a second end 60. The first end supports the continuous drive gear 52, and the second end supports the oscillating drive gear 54. The first and second ends each extend from a central pivot point 62 on engagement arm 56, forming an angle between the two ends. In the embodiment shown, the angle between the two ends is about 90 degrees. In other embodiments of the invention, this angle may be greater than or less than 90 degrees. Although the first and second ends are shown in this embodiment as elongated members extending from a central hub of a generally planar engagement arm, other configurations of an engagement arm are possible. Functionally, the engagement arm must be able to assume a first position in which only the continuous drive gear 52 engages the driven gear, and assume a second position in which only the oscillating drive gear 54 engages the driven gear.

To effect rotation of the first and second ends 58 and 60 about the pivot point 62, the rotatable engagement arm 56 may be configured with a third end 64 that rotates the engagement arm in response to motive force from a translating means. One example of a translating means includes the mode-selecting knob 22 that is shown throughout the drawings. Knob 22 may be connected to a rod or shaft 66 that is passed through the protective cover 18 and a support plate 68. Shaft 66, at its end opposite the mode-selecting knob, may be at least partially threaded, with the threaded end engaged within complimentary threading of a block 70. Block 70 may be pinned to the third end 64 of the engagement arm 56, so that rotation of shaft 66 draws block 70 either toward or away from the mode-selecting knob, causing rotation of the engagement arm 56 about its pivot point 62. Shaft 66 need not be threaded; however, by using a shaft threaded with proper tolerances, the position of block 70 and also the position of engagement arm 56 will remain fixed until an operator manually adjusts the mode-selecting knob. One or more bearings 69 and appropriate fastening hardware may be used to rotatably mount the shaft 66 through the support plate 68.

Various other means for translating the engagement arm are possible within the scope of the invention. For example, the end of shaft 66 may be fixed to the block 70, and the shaft may be allowed to thread in and out of the support plate 68. Or, an unthreaded shaft 66 may be pushed or pulled through a linear guide to effect rotation of the engagement arm. Or, a lever arm may be connected to the third arm 64, either directly or through some intermediate linkage. Alternatively, the third arm 64 may be extended for direct manipulation by an operator, or an electric or hydraulic motor may be used to rotate the engagement arm. In another embodiment, it is contemplated that a means for translating the engagement arm may comprise a hydraulic system (not shown) that derives motive force from the main flow 12.

The top view of FIG. 7 also shows components of the mechanical control system that allow the oscillating drive gear 54 to derive alternating motion from the continuous rotation of main drive gear 50. Components responsible for converting the continuous rotational motion of the drive shaft 48 into an alternating rotational oscillation include the drive shaft 48, a pivot drive arm 72, a drive shaft pivot 74, a push rod 76, and the oscillating drive gear 54. The pivot drive arm 72 may be formed from a planar material such as bar stock, and may be positioned at the top end of drive shaft 48 so that it extends normally from the axis of rotation, as shown. A slot 78 may be formed along an interior longitudinal length of the pivot drive arm 72. The slot 78 may have a width about the same diameter as drive shaft 48, so that it may receive the top end of drive shaft 48 at any position along its length. Drive shaft pivot 74 may fix the position of drive shaft 48 within slot 78, for example, by means of a clamp or cotter pin, so that the pivot drive arm 72 rotates freely about pivot point 62 along with the drive shaft.

Push rod 76 may be formed from rectangular or cylindrical bar stock. A proximal end 80 of push rod 76 may be pinned to the end of the pivot drive arm that is opposite pivot point 62, as shown, so that the proximal end 80 rotates in a circle having a radius equal to the distance between the proximal end 80 and pivot point 62. A distal end 82 of push rod 76 may be pinned to a driving arm 84 of the oscillating drive gear 54, and a center point 86 of the oscillating drive gear 54 may be pinned to the second end 60 of rotating arm 56. The oscillating drive gear may be configured to rotate about its center point 86 in response to displacement of its driving arm 84.

The operation of the oscillating drive gear is now described from the perspective of a top view of the mechanism as shown in FIG. 7. The overall motion of the pivot drive arm 72 and push rod 76 is similar to that of a crankshaft and piston rod in an internal combustion engine. In operation, clockwise rotation of drive shaft 48 causes concentric rotation of the pivot drive arm 72 and of the proximal end of push rod 76. As the proximal end of the push rod moves to the right-hand side of the mechanism, approaching a point on its circular path that is nearest to the mode-selecting knob 22, the push rod pulls the driving arm 84 to the right, thereby rotating the oscillating drive gear in a counterclockwise direction. As the proximal end of the push rod continues its rotation and begins to move toward the left-hand side of the mechanism, i.e., toward the position shown in FIG. 7, it begins to push the driving arm to the left, thereby rotating the oscillating drive gear in a clockwise direction. The clockwise rotation of the oscillating drive gear will continue until the proximal end of the push rod begins to rotate again toward the right-hand side of the mechanism, at which point it begins to pull the oscillating drive gear counterclockwise again. For every half cycle of continuous rotation of the drive shaft, the oscillating drive gear will alternate its rotational direction. In this manner, continuous rotational motion of the drive shaft may be converted into alternating rotational oscillation of the oscillating drive gear.

The angular span of the oscillating drive gear 54 may be adjusted by temporarily disconnecting the pivot drive arm 72 and sliding it with respect to pivot point 62 so that the top end of the drive shaft 48 is moved to a different position within slot 78. The pivot drive arm may then be re-connected to drive shaft 48 by means of main shaft pivot and 74 and appropriate fastening hardware. In the embodiment shown, the slotted pivot drive arm allows the angular span to be adjusted between about 25 degrees and about 125 degrees. Greater or lesser spans are possible within the scope of the invention.

In the embodiment shown, the proximal end 80 of push rod 76 lies at a higher elevation than the distal end 82, such that the push rod crosses the plane of the engagement arm 56. To prevent interference between the push rod and the engagement arm, a recess 88 may be formed on a side of the second end 60.

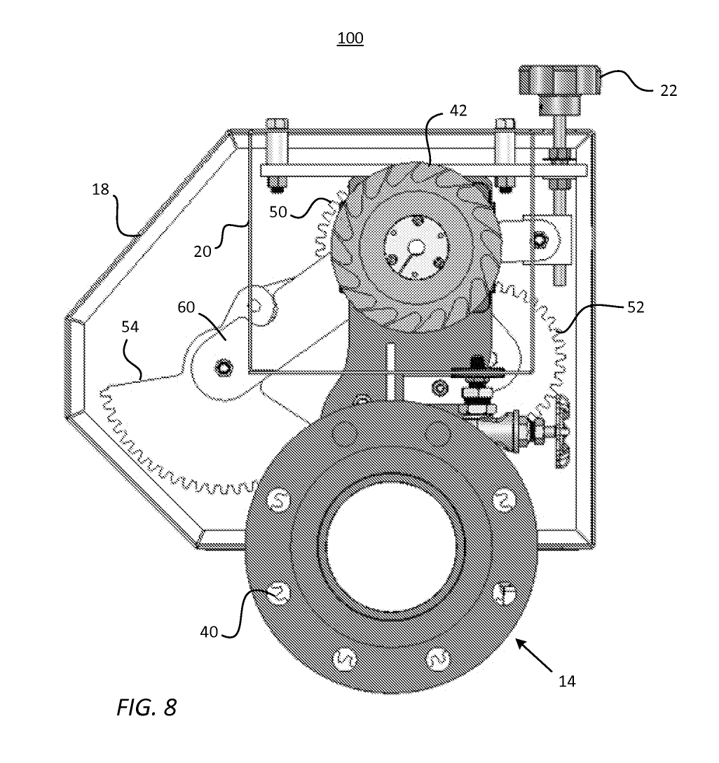

FIG. 8 shows a bottom view of waterway oscillator 100, with shield 20 in transparency. Mode-selecting knob 22 is in an intermediate position, so that neither drive gear is engaging the driven gear. This view illustrates an embodiment in which the fixed end 14 of main conduit 10 terminates in a flanged connection having a plurality of bolt holes around the perimeter of the flange for connecting the waterway oscillator 100 to a main source of fluid flow 12. An example of a blade pattern for the design of waterwheel 42 is also shown.

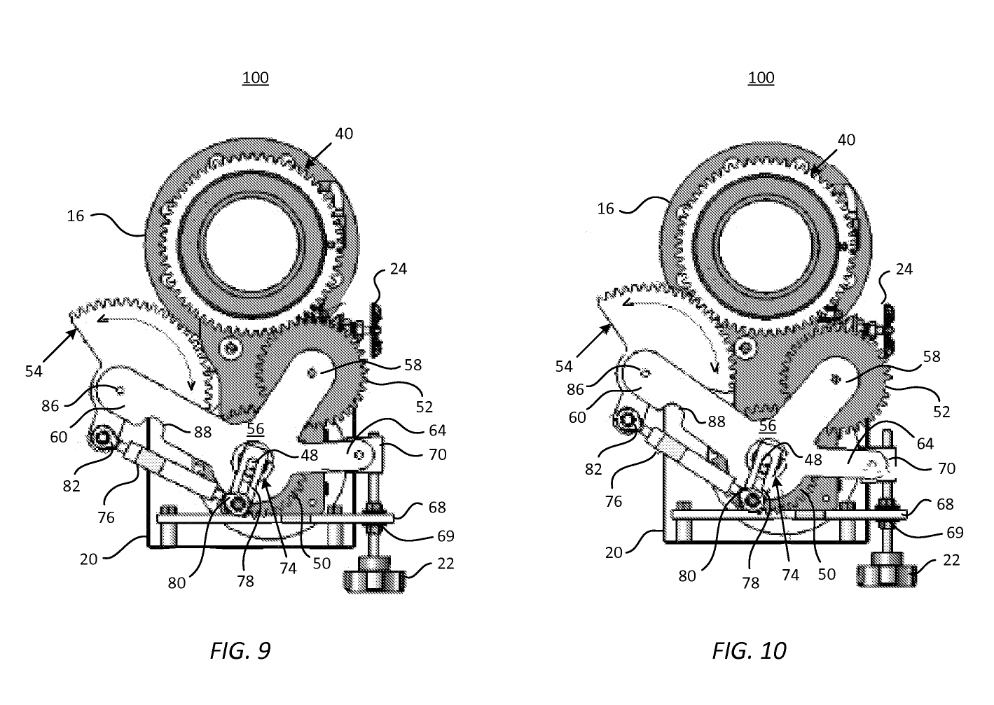

FIG. 9 shows a top cutaway view of waterway oscillator 100 in continuous rotational oscillation mode. In this mode, the mode-selecting knob 22 has been rotated a number of times in one direction, e.g. counterclockwise, to push block 70 away from support plate 68 and cause a counterclockwise rotation of engagement arm 60 until the continuous drive gear 52 has fully engaged both the driven gear 40 and the main drive gear 50. In this mode, the oscillating drive gear is disengaged from the driven gear, but may continue to oscillate.

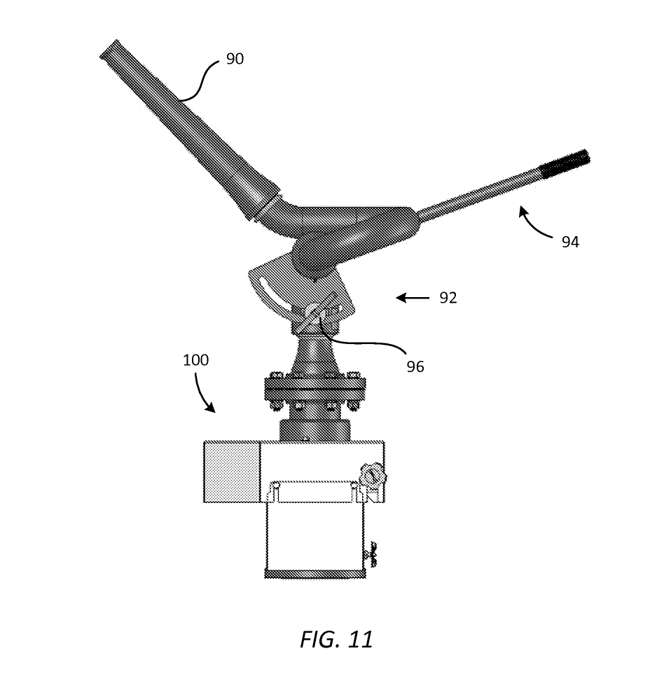

FIG. 10 shows a top cutaway view of waterway oscillator 100 in alternating rotational oscillation mode. In this mode, the mode-selecting knob 22 has been rotated a number of times in another direction, e.g. clockwise, to pull block 70 in toward support plate 68 and cause a clockwise rotation of engagement arm 60 until the oscillating drive gear 54 has fully engaged the driven gear 40. In this mode, the continuous drive gear is disengaged from the driven gear, but may remain engaged to main drive gear 50.

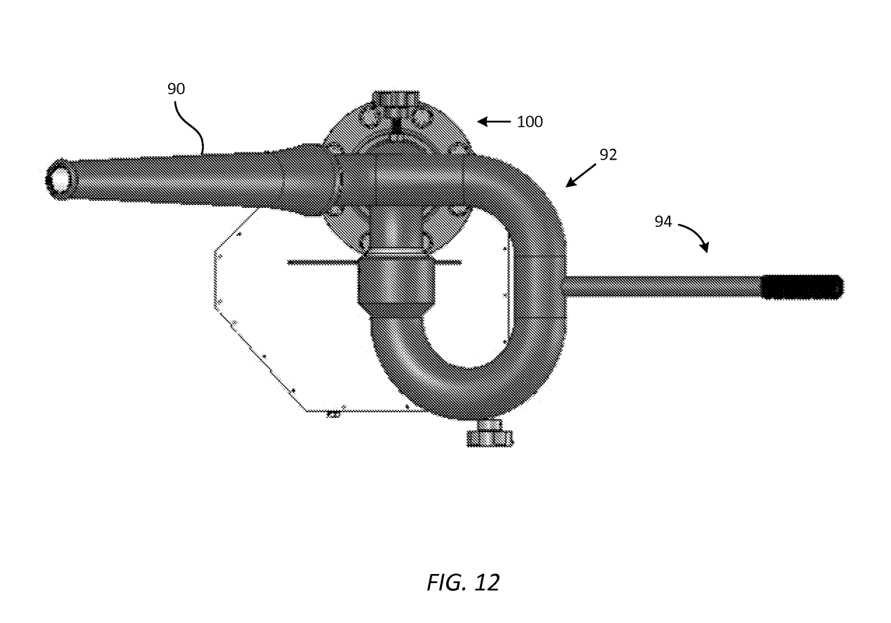

FIG. 11 shows a front view of waterway oscillator 100 equipped with a water cannon nozzle 90 and monitor assembly 92. The monitor assembly has been attached to the rotatable end of the main flow conduit by means of a flanged connection. The angle of the water cannon with respect to the horizon may be adjusted by means of the lever 94 and locking mechanism 96. When the desired angle is achieved, and with adequate flow through the main conduit, the waterway oscillator may be turned on using control valve 30. An oscillation mode may be selected using mode-selecting knob 22. FIG. 12 shows a top view of waterway oscillator 100 equipped with the water cannon nozzle and monitor.

A water powered, multi-mode waterway oscillator according to the invention may be used for industrial applications that require flow rates of up to about 3000 gpm and pressures up to about 100 psi. Given these ratings, and the corrosive environment created by the flow of water, materials of construction for the many parts and components described herein are preferably rugged, non-corrosive metals such as stainless steel, plated or coated steel, brass, and aluminum bronze. The design principles of the invention, and the sizes and ratings disclosed herein, may be scaled up or down according to the end use application.

A water powered, multi-mode waterway oscillator according to the invention achieves many objectives and advantages over state of the art waterway oscillators. It uses water pressure as the motive force for oscillating the waterway, so that no hydraulic or electrical energy sources are required for full operation. It provides both continuous rotational and alternating rotational oscillating modes in one control system. And it provides a convenient and easily manipulated manual controls for changing the oscillating mode, for adjusting the speed of oscillation, and for adjusting the angular span of the alternating oscillation.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A water-powered multi-mode waterway oscillator, comprising:
a main conduit directing a main flow of water and having a fixed end, a rotatable end, and a driven gear coupled to the rotatable end;
a control conduit redirecting a portion of the main flow from the main conduit to a control outlet;
a waterwheel configured to rotate a drive shaft in response to impact of water from the control outlet;
a main drive gear coupled to the drive shaft;
an engagement arm having a first end and a second end;
a continuous drive gear rotatably pinned to the first end and configured to engage the main drive gear and the driven gear;
an oscillating drive gear coupled to the drive shaft, rotatably pinned to the second end, and configured to engage the driven gear; and
a means for translating the engagement arm between first and second positions;
wherein, in the first position, the continuous drive gear engages the main drive gear and the driven gear to cause continuous rotation of the rotatable end of the main conduit; and
wherein, in the second position, the oscillating drive gear engages the driven gear to cause alternating rotation of the rotatable end of the main conduit.

2. The waterway oscillator of claim 1 wherein the rotatable end of the main conduit is configured for attachment to a water cannon nozzle.

3. The waterway oscillator of claim 1 further comprising a flow control valve installed between the main conduit and the control outlet.

4. The waterway oscillator of claim 1 wherein the waterwheel comprises a Pelton wheel.

5. The waterway oscillator of claim 1 wherein the waterwheel is coupled to the drive shaft through gear reduction.

6. The waterway oscillator of claim 1 wherein the engagement arm has a center of rotation concentric with the main drive gear.

7. The waterway oscillator of claim 6 wherein the main drive gear is concentrically coupled to the drive shaft.

8. The waterway oscillator of claim 1 further comprising
the oscillating drive gear having a geared end and a driving end and being pinned to the second end of the engagement arm at a pivot point between the geared end and the driving end;
a pivot drive arm coupled to an end of the drive shaft and extending perpendicularly therefrom; and
a push rod having a proximal end coupled to the pivot drive arm at a point displaced from the end of the drive shaft and having a distal end coupled to the driving end of the oscillating drive gear to convert continuous rotating motion of the drive shaft into alternating rotational motion of the oscillating drive gear about the pivot point.

9. The waterway oscillator of claim 8 wherein the pivot drive arm further comprises a means for adjusting displacement of the proximal end of the push rod from the end of the drive shaft to change rotational span of the oscillating drive gear.

10. The waterway oscillator of claim 1 wherein the means for translating rotates the engagement arm from the first position to the second position.

11. The waterway oscillator of claim 10 wherein the means for translating comprises a lever arm extending from the engagement arm.

12. The waterway oscillator of claim 11 wherein the lever arm is formed as an integral part of the engagement arm.

13. The waterway oscillator of claim 11 wherein the means for translating further comprises a threaded block coupled to the lever arm, a shaft threadably engaging the threaded block, and a manually operable knob coupled to the shaft, whereby rotation of the knob threads the block along the shaft to move the lever arm and rotate the engagement arm.

14. A fluid-powered mechanical oscillator comprising:
a rotatable main conduit directing a main flow of fluid;
a fixed control conduit redirecting a portion of the main flow;
a waterwheel configured to rotate a drive shaft responsive to receiving the redirected flow;
a continuous drive gear coupled to the drive shaft;
an oscillating drive gear coupled to the drive shaft; and
an engagement arm having first and second ends, the continuous drive gear rotationally mounted to the first end and the oscillating drive gear rotationally mounted to the second end, the engagement arm moveable between a first position wherein the continuous drive gear engages the main conduit to cause continuous rotation of the main conduit with respect to the control conduit and a second position wherein the oscillating drive gear engages the main conduit to cause alternating rotation of the main conduit with respect to the control conduit.

15. The waterway oscillator of claim 14 wherein the engagement arm is rotatable and has a center of rotation concentric with the drive shaft.

16. The waterway oscillator of claim 14 further comprising
the oscillating drive gear having a geared end and a driving end and being pinned to the second end of the engagement arm at a pivot point between the geared end and the driving end;
a drive arm coupled to an end of the drive shaft and extending perpendicularly therefrom; and
a push rod having a proximal end coupled to the drive arm at a point displaced from the end of the drive shaft and having a distal end coupled to the driving end of the oscillating drive gear to convert continuous rotating motion of the drive shaft into alternating rotational motion of the oscillating drive gear about the pivot point.

17. The waterway oscillator of claim 16 wherein the drive arm further comprises a means for adjusting displacement of the proximal end of the push rod from the end of the drive shaft to change rotational span of the oscillating drive gear.

18. The waterway oscillator of claim 14 wherein the engagement arm further comprises a lever arm extending from the engagement arm to effect rotation of the engagement arm between the first and second positions.

19. The waterway oscillator of claim 18 further comprising a mounting plate, a threaded shaft coupled to the lever arm though the mounting plate, and a manually operable knob coupled to the threaded shaft.

20. A mechanical oscillator comprising a rotatable conduit directing a flow of fluid and a fixed control conduit diverting a portion of the flow against a waterwheel coupled to a drive shaft which turns a continuous drive gear rotationally mounted to a first end of an engagement arm and an oscillating drive gear rotationally mounted to a second end of the engagement arm, the engagement arm moveable between a first position in which the continuous drive gear continuously rotates the main conduit with respect to the control conduit and a second position in which the oscillating drive gear causes alternating rotation of the main conduit with respect to the control conduit.
